(19) United States
(12) Patent Application Publication
(10) Pub. No.: US 2017/0124597 A1
(43) Pub. Date: May 4, 2017

(54) MARKETING OFFER PERSONALIZATION UTILIZATING DATA ANALYTICS OF SOCIAL MEDIA DATA

(71) Applicant: International Business Machines Corporation, Armonk, NY (US)

(72) Inventor: Subil M. Abraham, Lewisville, TX (US)

(21) Appl. No.: 14/926,370

(22) Filed: Oct. 29, 2015

(51) Int. Cl. G06Q 30/02; G06Q 50/00

(52) U.S. Cl. CPC G06Q 30/0271; G06Q 50/01; G06Q 30/0277

(57) ABSTRACT

Embodiments of the invention provide for marketing offer generation utilizing data analytics of social media data. A method for marketing offer generation utilizing data analytics of social media data is provided. The method includes selecting in memory of a host computing system a target end user to receive an automatically generated marketing offer and loading into the memory, a marketing offer that includes each of a recommendation for a product or service, personalized text pertaining to the product or service, and a mode of delivery. The method also includes querying a social media Web site with an identity of the target end user for content associated with the target end user and retrieving the content from the social media Web site and augmenting the marketing offer with the content. Finally, the method includes transmitting the augmented marketing offer to the target end user utilizing the mode of delivery.

### BACKGROUND OF THE INVENTION

Field of the Invention

The present invention relates to digital advertising and more particularly to personalized advertising content generation.

Description of the Related Art

The exponential growth of the Internet as a medium of commerce has resulted in a metamorphosis in the way in which products are promoted to consumers. Prior to the proliferation of common access to the World Wide Web, media promotion of different products and services had been limited to print media and radio and television media such that a single crafted message could be broadcast to thousands if not millions of viewers. Yet, given the nature of print media and radio and television media, no personalization of the advertising message had been possible in so far a single message is provided for each campaign.

In the context of the World Wide Web, however, advertising personalization is possible. In particular, the coupling of programmatic logic with content presentation in the Web environment permits an advertiser to probe data stored in connection with the browsing habits of each individual end user and to tailor advertising content delivered through the Web to each individual end user. Indeed, it is now common for the advertising content of a marketer customized for a specific end user based upon data at one Web site to appear as embedded content within another Web site. Consequently, recognizing the power of the Web, marketing expenditures are substantial with respect to the digital online, mobile and social media channels.

Initial attempts at advertising content personalization involved the use of cookies in which user profile information was stored. Based upon the data in the cookies, different textual messaging was selected for delivery to the end user. Subsequent attempts included the customized selection of product offerings based upon the known product tastes of the end user evident from the browsing habits of the end user. Recent advances in data and automated analytics, however, have obviated the need to utilize browser habits in order to personalize advertising content. Instead, automated analytics now enable the automated generation of powerful clues pertaining to consumer behavior so as to create targeted ways of reaching customers through the optimal selection of a digital marketing offer.

The use of automated analytics in automatically generating a marketing offer package consists primarily of (1) a recommendation for a product or service; (2) personalized content included as the offer message; (3) a mode of delivery such as television, the Web, mobile computing, social media or e-mail messaging; and (4), the presentation content such as audio, video or imagery. Substantial optimization and analysis has been conducted with respect to the first three foregoing aspects of a marketing offer packaging. However, deep personalization in the area of “presentation content” has often found to be lacking. Marketing teams still use stock images and other standard visual auditory content while packaging the marketing offer to consumers. Yet, presentation is as important as the marketing offer itself and studies have shown that consumers tend to remember the content of a message when the message is accompanied by a striking image which can establish an emotional connection to the individual.

### BRIEF SUMMARY OF THE INVENTION

Embodiments of the present invention address deficiencies of the art in respect to marketing offer generation and provide a novel and non-obvious method, system and computer program product for marketing offer generation utilizing data analytics of social media data. In an embodiment of the invention, a method for marketing offer generation utilizing data analytics of social media data is provided. The method includes selecting in memory of a host computing system a target end user to receive an automatically generated marketing offer and loading into the memory, a marketing offer that includes each of a recommendation for a product or service, personalized text pertaining to the product or service, and a mode of delivery. The method also includes querying a social media Web site with an identity of the target end user for content associated with the target end user and retrieving the content from the social media Web site and augmenting the marketing offer with the content. Finally, the method includes transmitting the augmented marketing offer to the target end user utilizing the mode of delivery.

In one aspect of the embodiment, the content is an image associated with a social media connection of the target end user in the social media Web site. In another aspect of the embodiment, the content is an audio track associated with the target end user in the social media Web site. In this regard, the audio track may be referenced in the social media Web site as a preferred song of the target end user. In yet another aspect of the embodiment, the marketing offer is a slide show presentation. Finally, in even yet another aspect of the embodiment, the method additionally includes computing a monetary value for the content and recording in fixed storage a payment obligation of the monetary value for the social media connection.

In another embodiment of the invention, a data processing system is configured for marketing offer generation utilizing data analytics of social media data. The system includes a host computing system that has at least one computer each with memory and at least one processor. The system also includes marketing offer generation computer program executing in the host computing system. The program includes computer program code enabled upon execution in the host computing system to select a target end user to receive an automatically generated marketing offer, to load into the memory, a marketing offer comprising each of a recommendation for a product or service, personalized text pertaining to the product or service, and a mode of delivery, to query over a computer communications network a social media Web site with an identity of the target end user for content associated with the target end user, to retrieve the content from the social media Web site and augmenting the marketing offer with the content and to transmit the augmented marketing offer to the target end user over the computer communications network utilizing the mode of delivery.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for marketing offer generation utilizing data analytics of social media data;

FIG. 2 is a schematic illustration of a data processing system configured for marketing offer generation utilizing data analytics of social media data; and,

FIG. 3 is a flow chart illustrating a process for marketing offer generation utilizing data analytics of social media data.

### DETAILED DESCRIPTION OF THE INVENTION

Embodiments of the invention provide for marketing offer generation utilizing data analytics of social media data. In accordance with an embodiment of the invention, a target end user is selected to receive a marketing offer. Thereafter, one or more social media Web sites are analyzed in order to identify content personal to the target end user and present within the one or more social media Web sites. For instance, the content may be audio content referenced on behalf of the target end user within one or more of the social media Web sites, or audio content similar to audio content referenced on behalf of the target end user within one or more of the social media Web sites. As well, the content may be imagery referenced on behalf of the target end user within one or more of the social media Web sites. As such, the identified content is used to augment the marketing offer into a highly personalized marketing offer.

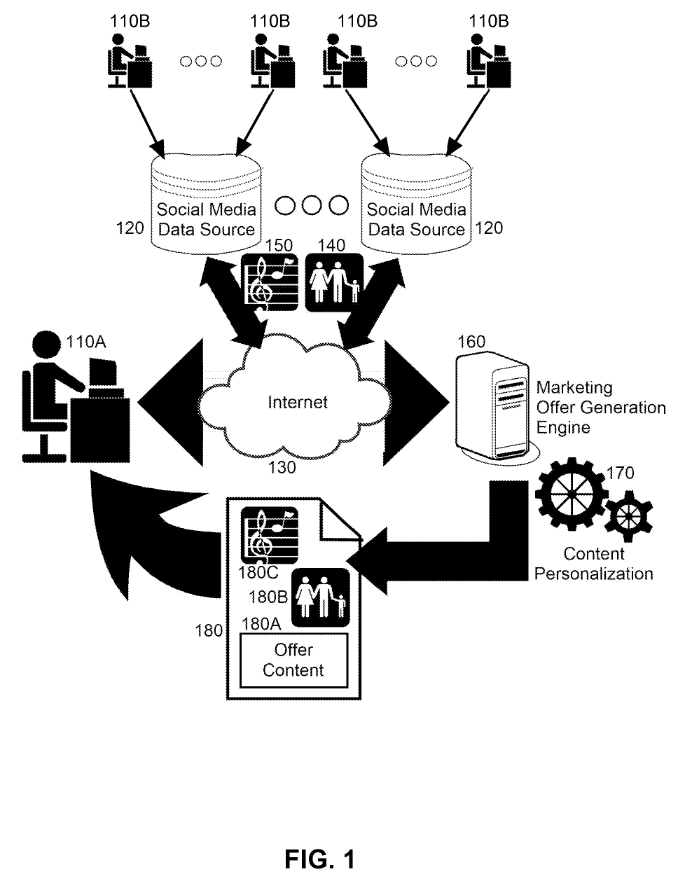

In further illustration, FIG. 1 pictorially shows a process for marketing offer generation utilizing data analytics of social media data. As shown in FIG. 1, a target end user 110A is selected in a marketing offer generation engine 160 to receive a personalized offer 180 constructed by the marketing offer generation engine 160 in respect to marketing offer content 180A such as a product or service textual description. Content personalization logic 170 coupled to the marketing offer generation engine 160 queries different social media data sources 120 from over the Internet 130 to identify content associated with the target end user 110A. In this regard, the content is imagery and/or video content 140, or audio content 150. Of note, the content is associated with the target end user 110A either directly within a corresponding one of the social media data sources 120, or indirectly in connection with one or more other end users 110B connected to the target end user 110A in corresponding ones of the social media data sources 120.

For instance, the imagery and/or video content 140 may be imagery or video content of one or more of the other end users 110B and tagged in connection with the target end user 110A. As another example, the audio content 150 may be music directly specified by the target end user 110A in one or more of the social media data sources 120, or the audio content 150 may be music known to be similar to music directly specified by the target end user 110A in one or more of the social media data sources 120. In any event, the content personalization logic 170 combines located imagery and/or video content 180B, located audio content 180C and marketing offer content 180A into a composite offer 180 that is then transmitted to the target end user 110A in accordance with a pre-determined mode of transmission, such as e-mail, text messaging or delivery within a Web browser.

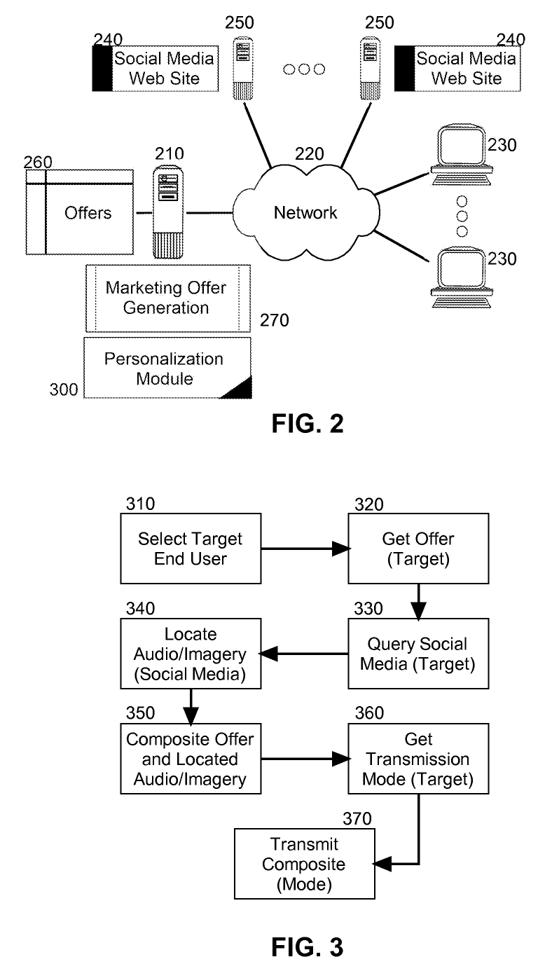

The process described in connection with FIG. 1 is implemented in a data processing system. In yet further illustration, FIG. 2 schematically shows a data processing system configured for marketing offer generation utilizing data analytics of social media data. The system includes a host computing system 210 that includes one or more computers, each with memory and at least one processor. The host computing system 210 supports the execution of a marketing offer generation computer program 270 configured to identify different target end users and corresponding marketing offers 260 for transmission to the target end users over computer communications network 220 to different end user computing devices 230, for example mobile computing devices or personal computers. In this regard each of the marketing offers 260 may be a digital advertisement, or even a more extensive digital document such as a slide show presentation.

A personalization module 300 is coupled to the marketing offer generation computer program 270. The personalization module 300 includes computer program code enabled upon execution in memory of the host computing system 210 to query different social media Web sites 240 provided in different servers 250 over computer communications network 220 to locate content associated with the target end user. In this regard, the associated content may be imagery (video or static) or audio stored within one of the social media Web sites 240 in connection with the target end user, either by the target end user him or herself, or by a connection to the target end user within the one of the social media Web sites 240. The program code additionally is enabled then to combine the located content with the marketing offer to produce a highly personalized marketing offer for delivery to the target end user.

In even yet further illustration of the operation of the personalization module 300, FIG. 3 is a flow chart illustrating a process for marketing offer generation utilizing data analytics of social media data. Beginning in block 310, a target end user is selected to receive a personalized marketing offer by way of a particular mode of delivery such as e-mail, text message or Web page. In block 320, a marketing offer is selected in correspondence with the target end user, for instance by referring to a table of marketing offers commensurate with a known characterization of the target end user as stored in a table.

In block 330, one or more social media Web sites are queries with respect to the target end user in order to locate social media content such as audio content, imagery or video content associated with the target end user. Thereafter, in block 340 the associated content is located and in block 350, a composite marketing offer is generated by combining the marketing offer selected in correspondence with the target end user with the located social media content. In block 360, a preferred mode of transmitting the composite marketing offer is determined, for instance in respect to the known characterization of the target end user. Finally, in block 370, the composite marketing offer is transmitted to the target end user utilizing the determined mode of transmission.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for marketing offer generation utilizing data analytics of social media data, the method comprising:
selecting in memory of a host computing system a target end user to receive an automatically generated marketing offer;
loading into the memory, a marketing offer comprising each of a recommendation for a product or service, personalized text pertaining to the product or service, and a mode of delivery;
querying a social media Web site with an identity of the target end user for content associated with the target end user;
retrieving the content from the social media Web site and augmenting the marketing offer with the content; and,
transmitting the augmented marketing offer to the target end user utilizing the mode of delivery.

2. The method of claim 1, wherein the content is an image associated with a social media connection of the target end user in the social media Web site.

3. The method of claim 1, wherein the content is an audio track associated with the target end user in the social media Web site.

4. The method of claim 3, wherein the audio track is referenced in the social media Web site as a preferred song of the target end user.

5. The method of claim 1, wherein the marketing offer is a slide show presentation.

6. The method of claim 2, further comprising computing a monetary value for the content and recording in fixed storage a payment obligation of the monetary value for the social media connection.

7. A data processing system configured for marketing offer generation utilizing data analytics of social media data, the system comprising:
a host computing system comprising at least one computer each with memory and at least one processor, and,
marketing offer generation computer program executing in the host computing system and comprising computer program code enabled upon execution in the host computing system to select a target end user to receive an automatically generated marketing offer, to load into the memory, a marketing offer comprising each of a recommendation for a product or service, personalized text pertaining to the product or service, and a mode of delivery, to query over a computer communications network a social media Web site with an identity of the target end user for content associated with the target end user, to retrieve the content from the social media Web site and augmenting the marketing offer with the content and to transmit the augmented marketing offer to the target end user over the computer communications network utilizing the mode of delivery.

8. The system of claim 7, wherein the content is an image associated with a social media connection of the target end user in the social media Web site.

9. The system of claim 7, wherein the content is an audio track associated with the target end user in the social media Web site.

10. The system of claim 9, wherein the audio track is referenced in the social media Web site as a preferred song of the target end user.

11. The system of claim 7, wherein the marketing offer is a slide show presentation.

12. The system of claim 8, wherein the program code upon execution is further enabled to compute a monetary value for the content and to record in fixed storage of the host computing system a payment obligation of the monetary value for the social media connection.

13. A computer program product for marketing offer generation utilizing data analytics of social media data the computer program product comprising a computer readable storage medium having program instructions embodied therewith, the program instructions executable by a device to cause the device to perform a method comprising:
selecting in memory of a host computing system a target end user to receive an automatically generated marketing offer;
loading into the memory, a marketing offer comprising each of a recommendation for a product or service, personalized text pertaining to the product or service, and a mode of delivery;
querying a social media Web site with an identity of the target end user for content associated with the target end user;
retrieving the content from the social media Web site and augmenting the marketing offer with the content; and,
transmitting the augmented marketing offer to the target end user utilizing the mode of delivery.

14. The computer program product of claim 13, wherein the content is an image associated with a social media connection of the target end user in the social media Web site.

15. The computer program product of claim 13, wherein the content is an audio track associated with the target end user in the social media Web site.

16. The computer program product of claim 15, wherein the audio track is referenced in the social media Web site as a preferred song of the target end user.

17. The computer program product of claim 13, wherein the marketing offer is a slide show presentation.

18. The computer program product of claim 14, wherein the method further comprises computing a monetary value for the content and recording in fixed storage a payment obligation of the monetary value for the social media connection.
